(19) United States
(12) Patent Application Publication
(10) Pub. No.: US 2004/0070158 A1
(43) Pub. Date: Apr. 15, 2004

(54) Snow recreation device

(76) Inventors: David J. Fitzgerald, Hayward, CA (US); Matthew R. Zilinskas, San Francisco, CA (US); Terry J. Sanchez, Vacaville, CA (US)

Correspondence Address: KOLISCH HARTWELL, P.C., 520 S.W. YAMHILL STREET, SUITE 200, PORTLAND, OR, 97204, US

(21) Appl. No.: 10/349,241

(22) Filed: Jan. 21, 2003

Related U.S. Application Data
(60) Provisional application No. 60/351,175, filed on Jan. 21, 2002.
(60) Provisional application No. 60/351,177, filed on Jan. 21, 2002.

(51) Int. Cl. B62B 13/00

(52) U.S. Cl. 280/18

(57) ABSTRACT

A snow recreation device is provided. The device is defined by a convex bottom surface that includes tracking and steering ridges. In some embodiments, the device includes raised handles configured to position a rider's grip above the bottom surface of the device.

### CROSS-REFERENCE TO RELATED APPLICATION

This application is based on and claims priority under 35 U.S.C. § 119 from the following co-pending provisional patent applications, which are incorporated herein by this reference, in their entirety and for all purposes: LUGE SNOW SLED, Serial No. 60/351/175, filed Jan. 21, 2002, and SKELETON SNOW SLED, Serial No. 60/351,177, filed Jan. 21, 2002.

### BACKGROUND OF THE INVENTION

Snow provides a recreational opportunity for individuals of all ages. Such individuals may utilize sleds, skis, snowboards, and similar devices to slide on the snow. Sleds generally are configured to allow an individual to slide in either a seated or lying position. To slide in a standing position, a pair of skis may be attached to an individual's feet. Alternatively, an individual may use a unitary snowboard, which typically includes bindings for holding the individual's feet in place. To facilitate turning, skis and snowboards typically have sharpened edges with enough flex to allow cutting into the snow in an arched orientation, which effectuates a change of direction. Some sleds include rails to facilitate steering.

### SUMMARY OF THE INVENTION

A snow recreation device is provided. The device is defined by a convex bottom surface that includes tracking and steering ridges. In some embodiments, the device includes raised handles configured to position a rider's grip above the bottom surface of the device.

### BRIEF DESCRIPTION OF THE DRAWINGS

FIGS. 1-8 are respectively top plan, side, side cross-section, bottom plan, front cross-section, front cross-section, front cross-section, and front views of a snowboard with raised handles.

FIG. 9 is a top plan view of a sled constructed according to one embodiment of the present invention, showing a central area for the rider's body and three pairs of handhold positions along the sides.

FIG. 10 is a side cross-section of the sled of FIG. 9.

FIG. 11 is a side elevation view of the sled of FIG. 9, showing one side of the handhold positions and three steering ridges on the bottom of the sled.

FIG. 12 is a bottom plan view of the sled of FIG. 9, showing left and right sets of the three steering ridges.

FIG. 13 is a front elevation view of the sled of FIG. 9, showing the front pair of handholds and the height of the steering ridges.

FIG. 14 is a top plan view of a sled constructed according to the present invention, showing an aft seating position, a smaller forward seating position, a pair of side handles, and leg and foot trays, with raised bumps distributed in the foot areas for traction.

FIG. 15 is a side cross-section of the sled of FIG. 14, showing a leg and foot tray and the aft seating position.

FIG. 16 is a side elevation view of the sled of FIG. 14, showing one of the handles and the edges of three steering ridges.

FIG. 17 is a bottom plan view of the sled of FIG. 14, showing left and right sets of the three steering ridges.

FIG. 18 is an inverted front elevation view of the sled of FIG. 14, showing the height of the steering ridges.

### DETAILED DESCRIPTION OF THE PREFERRED EMBODIMENTS

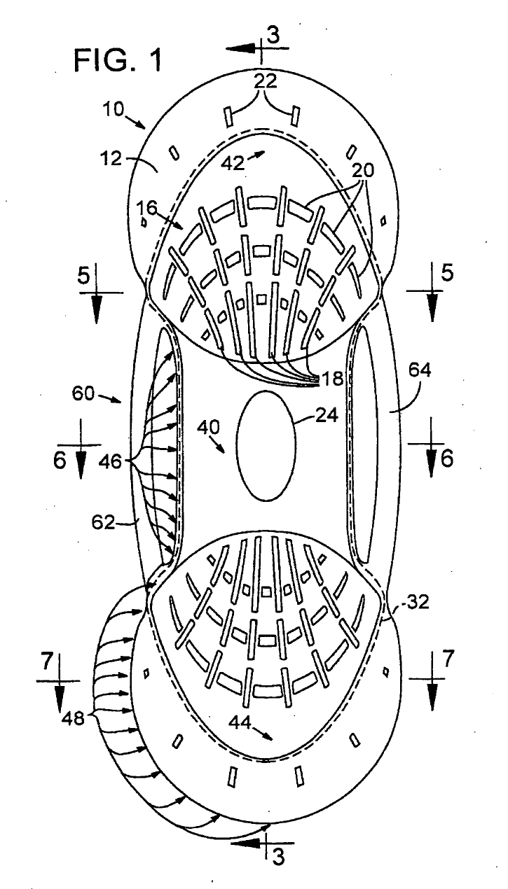

FIGS. 1-8 show a snowboard 10 designed to carry an individual over snow equally well in either a standing, sitting, or lying position. When lying, an individual may be positioned face up or face down. Although typically sized to accommodate a single rider, the snowboard may be simultaneously used by more than one rider. The snowboard is generally symmetrical from side to side and from end to end. Therefore, the snowboard may be used to ride downhill or travel along flat areas in either direction, which is particularly useful when performing tricks where the snowboard is rotated 180 degrees.

Snowboard 10 may be manufactured from rigid high-density polyethylene. The snowboard is typically blow molded with a wall thickness of approximately 0.08 to 0.12 inches. The snowboard is defined by a top surface 12, shown in FIG. 1, and a bottom surface 14 shown in FIG. 4. Top surface 12 is sized and shaped to support a rider in numerous riding positions according to a rider's preference. To this effect, the snowboard is large enough to accommodate a rider in a prone position, but small enough to be easily maneuverable when a rider is in a standing position. In the illustrated embodiment, the snowboard is approximately 36 inches long, with a width that varies along the length, reaching a maximum of approximately 12 inches at opposite end portions of the snowboard and approximately 8 inches at a middle portion of the snowboard.

Top surface 12 includes a gripping pattern 16 configured to increase the friction or purchase between the snowboard and a rider's feet, or the rider's body when in a prone position, so that the rider can better control the snowboard. In the illustrated embodiment, gripping pattern 16 includes a series of lowered features, which provide traction. In particular, the illustrated embodiment includes lowered recesses 18 and 20 orientated approximately 1/16 inch below the basic top surface. As illustrated, recesses 18 are arranged in a staggered spoke design that flairs out at the ends. The recesses 20 are arranged in staggered arcuate bands, which are interrupted by recesses 18. In some embodiments, different patterns and/or different feature sizes may be used to generate a desired traction, although gripping pattern 16 has been found to provide adequate traction in most circumstances. Furthermore, raised bumps may additionally or alternatively be used. The top surface may be further augmented from the illustrated embodiment with grip tape or similar friction enhancers to further improve traction, although this may lessen the utility of the snowboard as a sled, because the grip tape may damage a rider's clothes when in a lying position. In general, gripping pattern 16 is positioned on top surface 12 where a rider's feet are most often positioned, because increased traction is often beneficial when in a standing position.

The snowboard may also include one or more padding assemblies affixed to the top surface, shown in dashed lines at 32 of FIG. 1. Such padding assemblies may be used to improve the comfort of the snowboard when it is used in seated or lying positions, as well as purchase when the rider stands. Padding assembly 32 may be constructed out of low density polyethylene foam having a thickness of approximately ⅛ to 3/16 inch. The surface of a padding assembly may be textured to improve traction between the snowboard and a rider. Similarly, the surface of a padding assembly may include recesses and/or bumps, similar to gripping pattern 16, to further improve traction. As shown, the pad is positioned equal distances from both ends of the board, and it approximately 20 inches long, although other sizes and positions may be used.

Gripping pattern 16 also includes end “reminders” 22 that are approximately ⅛ inch protrusions from the basic top surface of the snowboard. The end reminders are located on the top surface near opposite ends of the snowboard, and they serve a dual function. First, like the raised bumps, they improve traction between a rider and the snowboard. In the case of reminders 22, this improves a rider's ability to maneuver the ends of the snowboard. Second, the reminders are also configured and positioned to help a rider identify the end of the snowboard without looking, so that a rider may feel when a foot is nearing the end of the board. This is useful when a rider is frequently changing riding stances, as is often necessary when performing tricks. For example, a rider may position a foot near the end of a board when performing an ollie, a kickflip, or other trick. The end reminders assist the rider in properly positioning his/her feet, and using his/her feet to move the snowboard as desired.

Snowboard 10 also includes an emblem 24, which may be textured to enhance traction. In the illustrated embodiment, emblem 24 is positioned at the center of the top surface of the snowboard. In some embodiments, more than one emblem may be present. Interchangeable emblems, where one emblem may be removed and replaced with another emblem, may be provided as a means for riders to customize their snowboards. For example, a snowboard may include a permanent brand emblem, displaying a manufacturer's trademark, for instance; and an interchangeable emblem designed to display a rider identifier. This may be useful when several riders have snowboards of the same color and appearance, so that the riders can easily distinguish one snowboard from another.

The Form and Configuration of the Snowboard Body

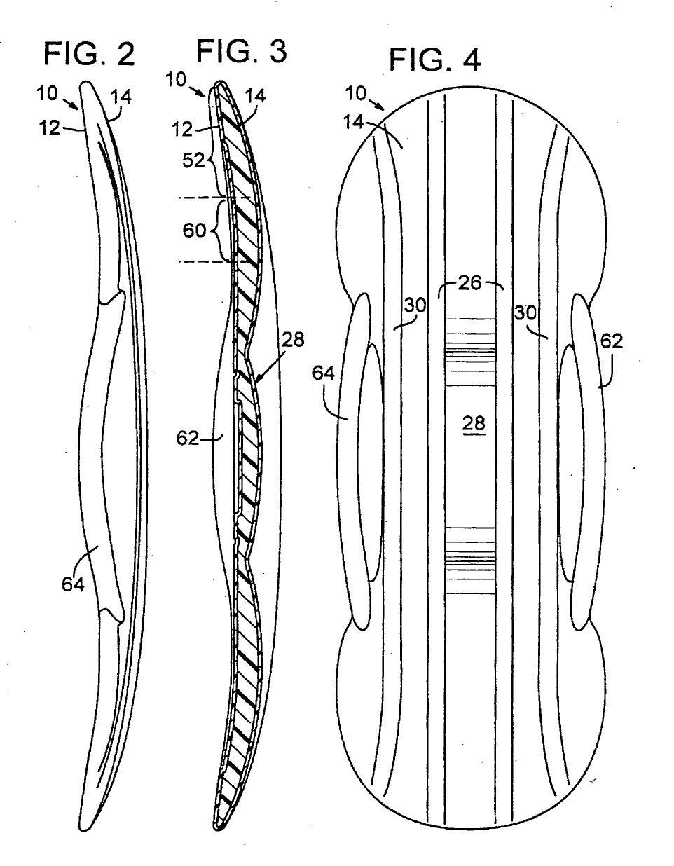

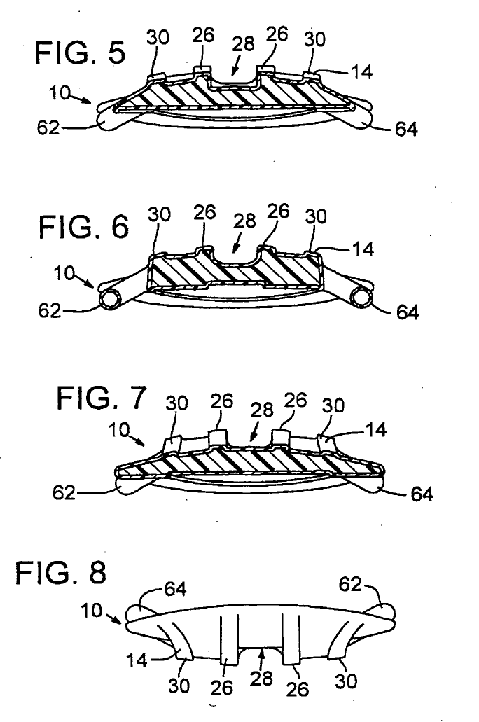

Bottom surface 14 has a generally convex shape. As shown in FIGS. 2 and 3, the bottom surface has a slight arc from end to end. In the illustrated embodiment, the amount of end-to-end curvature is greatest near the ends of the snowboard, with a slighter amount of curvature being present near the middle of the snowboard. Increased curvature at the ends helps the snowboard slide on snow, and is useful when a rider attempts to manuel (wheelie). FIGS. 5-8 show that bottom surface 14 also arcs from side to side. As explained in more detail below, the side-to-side arc is interrupted by ridges running from end to end along the bottom surface and configured to assist in tracking and steering. The side-to-side arc allows a rider to determine which ridges the snowboard primarily uses, thus allowing the rider to control and steer the snowboard. The illustrated embodiment is provided as an example, and should not be considered limiting. Bottom surface 14 may be configured with other convex curvatures, specifically designed to impart desired characteristics to the snowboard.

FIGS. 4 and 10 show tracking ridges 26, between which is a tracking channel 28, and steering ridges 30 located on the bottom surface of the snowboard. Tracking ridges 26 run or extend from end to end in a generally straight line. They are located at the bottom of the convex curvature near the middle of the snowboard. In the illustrated embodiment, two tracking ridges 26 are shown, although more or fewer tracking ridges may be included in other embodiments. The tracking ridges are configured to engage the snow when a rider is evenly balanced on the snowboard. The ridges are rectilinear to help direct the snowboard in a straight path. Tracking channel 28 is configured to increase the stability of the snowboard, and to further assist the snowboard in traveling in a straight line. The precise size and shape of the tracking ridges may vary between embodiments, with tracking ridges between approximately ¼ and 3/2 inch appropriate for most uses. Similarly, the tracking channel may be variously sized, with a depth of up to approximately 3 inches being appropriate in most circumstances. Furthermore, the height and depth of the ridges and/or channels may vary along the length of the snowboard. For example, as shown in FIG. 3, tracking channel 28 deepens as it approaches the middle of the snowboard from the ends, with an arcing decrease in depth occurring at the middle of the snowboard.

Between the tracking ridges and each side of the snowboard, the bottom surface includes an elongate steering ridge 30. Each steering ridge symmetrically arcs outwardly from the middle of the snowboard. The curving disposition of the steering ridge may be continuous or variable. For example, the amount of curvature may increase near the ends of the snowboard. The steering ridges generally have a substantially parabolic curvature, which helps a rider to turn the snowboard. A rider can weight shift to either side of the snowboard to cause the steering ridge on that side to dig deeper into the snow and cause the snowboard to turn. Unlike traditional skis and snowboards, the snowboard does not usually include a sharpened edge for turning. Therefore, snowboard 10 is safer than conventional skis and snowboards. However, some of the features described herein may be incorporated into devices that do use sharpened edges.

The relatively narrow width of the snowboard allows the steering ridges to be engaged by a rider in a standing position. If the board was substantially wider, the amount of weight shift required to cause the snowboard to utilize the turning ridges would be much greater, and therefore, the snowboard would be more difficult to ride in a standing position. Therefore the snowboard is typically no greater than 24 inches wide, and preferably no greater than 18 inches wide, and even more preferably, no greater than 14 inches wide. In addition to facilitating quick turning, narrow boards are also lighter, which is generally beneficial to riders performing tricks that require the snowboard to flip, spin, twist, or otherwise be maneuvered.

As shown in FIG. 1, top surface 12 is configured to support a rider in standing, sitting, and/or lying positions. As described above, the top surface includes a gripping pattern configured to provide a rider with traction. The top surface is also shaped to improve the rider's ability to control the snowboard. For purposes of explanation, the body of the snowboard may be divided into three basic portions: a middle portion 40, and opposing end portions 42 and 44. The perimeter 46 of the middle portion is generally rectilinear, and is flanked by end portions with generally elliptical perimeters 48. In other words, the snowboard has somewhat rounded ends joined by a relatively narrow, when compared to the ends, middle portion that is not as rounded as the end portions. This is different than conventional snowboard designs, which generally are not substantially wider at the ends than at the middle, or at least gradually change widths along the entire length of the board as opposed to changing perimeter geometry at discrete intervals. As will be explained in detail below, the illustrated design facilitates the inclusion of a handle assembly, which is not found on conventional snow boards.

Middle portion 40 has a substantially flat top surface, which may also be referred to as a riding platform. The flat portion of the middle portion is approximately 24 inches, although it may be longer or shorter in other embodiments. The riding platform generally extends partially into the top surface of the end portions, and then transitions into a top surface with an upwardly curving concave shape. As illustrated, the top surface curves up towards the end of the board, with the ends curving up uniformly across the width of the board. As best shown in FIG. 3, the concave curving section 50 of the end portion may end before the end of the board, and the angle of incline may continue in a more linear fashion along a generally flatly inclining section 52. In some embodiments, the top surface may also curve up towards the sides of the board. The riding platform may also include a top surface with a relatively small amount of end-to-end and/or side-to-side concave curvature.

The precise location the snowboard transitions from having a substantially flat top surface to an upwardly curving concave top surface may be selected to achieve a desired handling characteristic. Other modifications may also be made to the general shape illustrated. For example, the concave curvature of the end portions may be made symmetric about the center of the end portions. In some embodiments, the curvature may be made to rise up from the center of the end portions at different slopes from center to end, center to side, etc. For example, the top surface may have a steeper curve going from the center of the end portion to the end of the board than from the center of the end portion to the sides of the board.

The shape of the riding platform enables a rider to mount the feet in a substantially flat orientation, and thereby closely engage the board, so that the rider can precisely control the snowboard. The configuration enables a rider to place both feet against the flat surface, when desired, or to place one or more feet on the concave portion. Standing with both feet on the flat portion of the riding platform is often the starting position for many tricks and maneuvers. In a normal downhill riding position, the rider typically has a lead foot on the flat portion of the riding platform and a trailing foot on a corresponding concave end portion. That facilitates stability of the trailing foot and leg, which aids control during riding, particularly during travel at relatively high speeds. The concave curvature of the end portion additionally enables a rider to better “rock” the snowboard side-to-side and/or end-to-end, which is useful in performing tricks, and in shifting weight to cause the snowboard to turn. Unlike conventional snowboards and skis, the top surface 12 and bottom surface 14 of snowboard 10 do not closely correspond or run parallel to one another. This is due in large part because the snowboard does not include bindings, and therefore the top surface is specially configured to support a rider that is not fastened to the snowboard.

The Handle Assembly

As best shown in FIGS. 1 and 2, snowboard 10 includes a handle assembly 60. Handle assembly 60 includes a handle 62 on one side of the snowboard, and a handle 64 on the other side of the snowboard. The handles are fixedly attached to the body of the snowboard in an integrated relationship. As shown, each handle joins with the body at two locations, one on each end of the board. As with the rest of the snowboard, the handles are symmetrically configured and placed, so that the board may be ridden with either end forward. As illustrated, the handles are approximately 14 inches long. In some embodiments, the handle length may be modified, such as in a range between 5 and 20 inches.

Handles 62 and 64 are each configured as raised handles that position a rider's grip above the bottom surface of the board's body. Therefore, a rider may hold onto the handle while using the snowboard, without the hand engaging or dragging against the snow, which may be uncomfortable to the rider and impede forward travel and ability to maneuver. As shown in FIG. 2, the handle may have an upper surface approximately 3 to 6 inches above the bottom surface of the board's body. The lower surface of the handle may be approximately 1 to 3 inches above the bottom surface of the board's body. In any case, the criteria is that for most riding conditions, where the rider grips either handle, the rider's hand will be elevated sufficiently above the snow, or the packed portion of the snow in powder conditions. The relative length of the handle improves the handle's utility when used in various positions, such as a seated or lying position. Furthermore, the length of the handle provides a rider with a large target to grab while performing tricks that involve gripping the handle, such as required in many airborne maneuvers and jumps, to keep the board in position. The rigid handle provides ample support when complicated tricks such as handstands are performed. If the handle were not made of rigid material, such as rigid polyethylene, it may deflect or deform, which would cause a rider to lose control.

Handle assembly 60, which rises above the top surface of the body, is shaped so as to help position a rider in a seated or lying position. The handle assembly provides lateral support that helps secure the rider. When in a standing position, the rider may use the handle as a toe hold and/or heel back to more precisely control the board, and/or to maneuver the board during tricks. For some hands-free tricks, this is very beneficial because the board does not include bindings or other fasteners for securing the rider to the board. Another attribute of handle assembly 60 is that it may be used to carry the board, such as when a rider is walking up a hill.

The Form and Configuration of the Skeleton Body

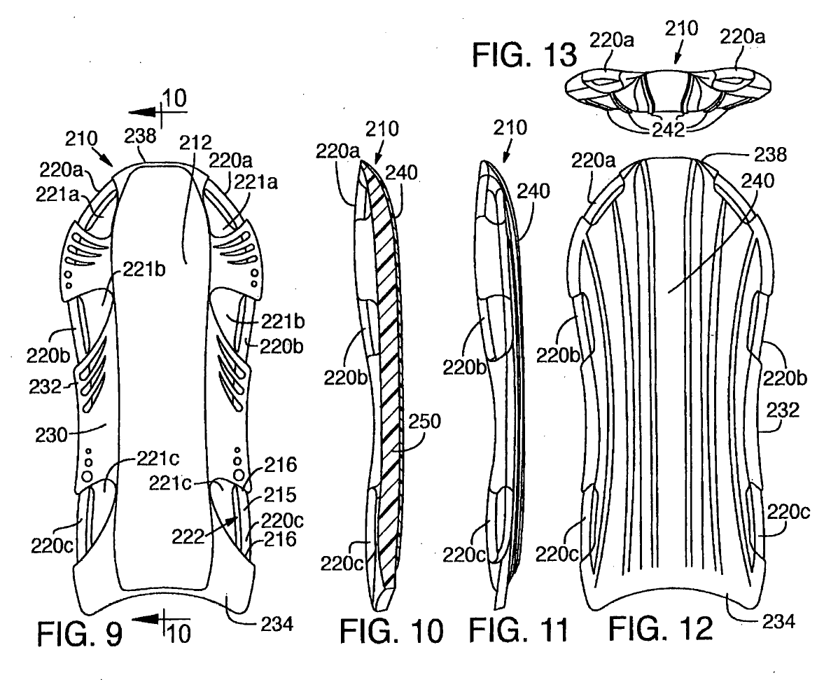

As shown in FIG. 9, a sled, indicated generally at 210, according to an embodiment of the present invention is a skeleton-style sled. That is, it is for a single rider to occupy preferably in a prone position. Thus, sled 210 includes a central area 212, generally extending from adjacent a nose 238 to adjacent a tail 234 of sled 210. Central area 212 is typically roughly rectangular in outline and preferably includes a sheet of foam plastic 213 adhered to a top surface 230 of the sled. Three pairs of handles 220a, 220b, 220c run along the sides of sled 210, and the rider can hold onto any of handles 220a-c. Handles 220a-c may include a central portion 215 between ends 217, wherein central portion 215 is separated from the body of sled 210 by an opening 222, but alternatively the opening may be closed by a web or other suitable means to prevent snow from flowing onto the sled through the opening. Sled 210 typically includes cutaways 221a, 221b, 221c adjacent corresponding handles 220a-c to provide access for the rider's thumbs or fingers to the handles.

Upper surface 230 of the sled typically has a generally hourglass-shaped outline 232, a crescent-shaped tail 234, and one or more scallop-shaped or circular depressions.

Sled 210 is preferably formed by blown-injection molding using any plastic material, e.g., polyethylene, or other suitable material. Such construction is light-weight, inexpensive, and durable. Sled 210 thus typically includes a hollow central cavity 250.

Sled 210 includes a bottom surface 240 (FIGS. 10-13) opposite top surface 230, upon which the snow rests when used on snow. Bottom surface 240 is generally convex and includes two sets, left and right of splayed ridges 242, which aid in steering the sled as it travels along on snow or other ground cover. Ridges 242 are raised above bottom surface 240 and typically define generally parabolically curved shapes. Sled 210 tends to track along directions pointed to by the curves of ridges 242 because the ridges tend to extend into the snow. Thus, when sled 210 is tilted to one side, so that the sled is riding more on the ridges of one side than the ridges of the other, the sled will tend to turn, by interaction of the ridges and the snow, toward the side upon which the sled is tilted. When sled 210 is in equilibrium from side to side, it tends to ride straight along the centerline 244 of the sled. Size, number, and shape of the ridges may be varied in order to suit the preferences for particular riding styles or conditions, although the ridges specifically described herein are believed generally applicable to a variety of riding styles and conditions. Bottom surface 240 also includes a channel 246 typically running from nose 238 to tail 234. Typical dimensions for sled 210 are indicated in inches in FIGS. 9 and 11.

A rider in a prone position may grip one of the first pair of handles 220a on one side of the sled body and one of the third pair of handles 220b on the other side of the sled body and use this grip to shift the rider's weight and cause the sled to turn. Additionally, a rider in a seated position may grip both of the second pair of handles 220c shift the rider's weight toward one side and cause the sled to turn in the direction the rider's weight was shifted.

The Form and Configuration of the Luge Body

As shown in FIG. 14, a sled, indicated generally at 310, according to another embodiment of the present invention is a luge-style sled. That is, it is for one or two riders to occupy preferably in a seated position, with the legs extending straight out in front of the rider. Thus, sled 310 includes an aft seating position 312, characterized by a generally circular depression 314. A forward seating position 316 on sled 310 includes a depression 318, that is typically smaller than that of aft seating position 312, and thus, the forward seating position is typically used by a smaller rider, e.g., a child, although persons of any typical size can be accommodated on the sled. A pair of arched handles 320 run alongside the seating positions 312, 316, where both riders can hold onto the handles. Handles 320 are shown as defining a separate arch defining an opening 322 between the handle and the body of the sled, but alternatively, the opening may be closed by a web or other suitable means to prevent snow from flowing onto the sled through the opening.

The sled includes leg and foot trays 324 in front of the seating positions where the riders can place their legs. Trays 324 include a high-friction area, such as that formed by raised bumps 326, where the riders can securely place their feet. The trays may also include one or more scallop-shaped depressions 328.

An upper surface 330 of the sled, upon which the foregoing features are provided, typically has a generally hourglass-shaped outline 332, a crescent-shaped tail 334, and a central channel 336 that extends along the length of the sled from nose 338 to tail 334, although it is interrupted for the seating depressions.

Sled 10 is preferably formed by blown-injection molding using any plastic material, e.g., polyethylene, or other suitable material. Such construction is light-weight, inexpensive, and durable. Sled 10 thus typically includes a hollow central cavity 50.

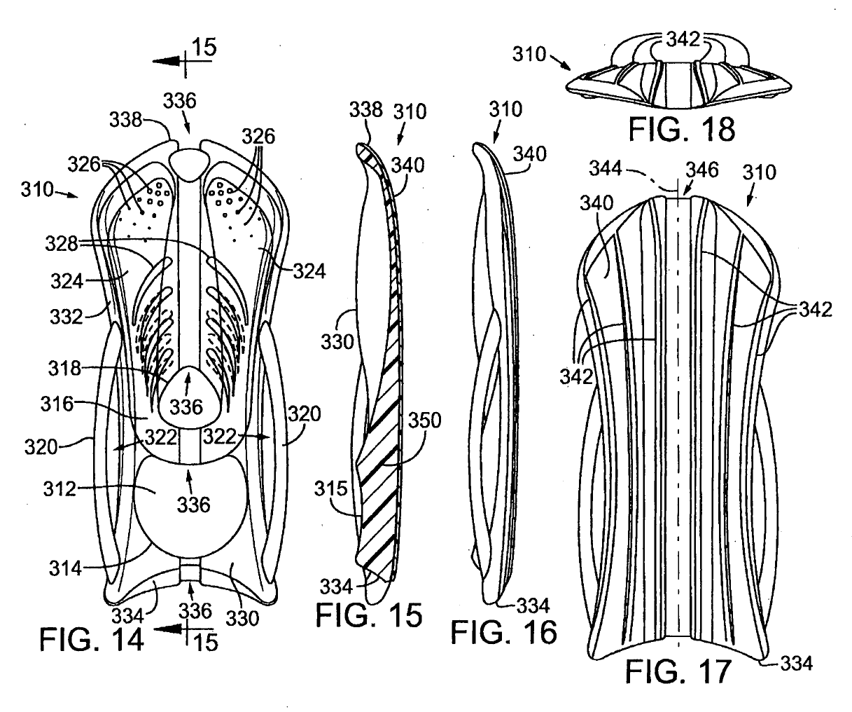

Sled 310 includes a bottom surface 340 (FIGS. 15-8) opposite top surface 330, upon which the snow rests when used on snow. Bottom surface 340 is generally convex and includes two sets, left and right of splayed ridges 342, which aid in steering the sled as it travels along on snow or other ground cover. Ridges 342 are raised above bottom surface 340 and typically define generally parabolically curved shapes. Sled 310 tends to track along directions pointed to by the curves of ridges 342 because the ridges tend to extend into the snow. Thus, when sled 310 is tilted to one side, so that the sled is riding more on the ridges of one side than the ridges of the other, the sled will tend to turn, by interaction of the ridges and the snow, toward the side upon which the sled is tilted. When sled 310 is in equilibrium from side to side, it tends to ride straight along the centerline 344 of the sled. Size, number, and shape of the ridges may be varied in order to suit the preferences for particular riding styles or conditions, although the ridges specifically described herein are believed generally applicable to a variety of riding styles and conditions. Bottom surface 340 also includes a channel 346 typically running from nose 338 to tail 334.

Typical dimensions for sled 310 are indicated in inches in FIGS. 14 and 16. Sled 310 may be used by the riders in a prone position, a seated position, or other positions.

It is believed that the disclosure set forth above encompasses multiple distinct inventions with independent utility. While each of these inventions has been disclosed in its preferred form, the specific embodiments thereof, as disclosed and illustrated herein, are not to be considered in a limiting sense as numerous variations are possible. The subject matter of the inventions include all novel and non-obvious combinations and sub-combinations of the various elements, features, functions and/or properties disclosed herein. Where claims recite “a” or “a first” element or equivalent thereof, such claims should be understood to include incorporation of one or more such elements, neither requiring, nor excluding two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of those claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. A snowboard, comprising:
a body having a generally convex bottom surface configured to slide over snow and an opposing top surface configured to support a rider; wherein the body includes a middle portion having a substantially flat top surface, and opposing end portions, each having an upwardly curving concave top surface; and
a pair of raised handles mounted to opposite sides of the body, wherein each handle is configured to position a rider's grip above the bottom surface of the body.

2. The snowboard of claim 1, wherein each handle is centered between opposing ends of the body.

3. The snowboard of claim 1, wherein each handle is at least 10 inches long.

4. A snowboard, comprising:
a body defined by a perimeter with a generally rectilinear middle portion flanked by opposing elliptical end portions;
a handle assembly including a handle running along each side of the body, wherein each handle is configured to position a rider's grip above the bottom surface of the body.

5. The snowboard of claim 4, wherein the rectilinear middle portion has a maximum width between 7 and 10 inches, and the elliptical end portions each have a maximum width between 11 and 14 inches.

6. The snowboard of claim 4, wherein each handle of the handle assembly is centered between opposing ends of the body.

7. The snowboard of claim 4, wherein each handle of the handle assembly is at least 10 inches long.

8. A snow sled, comprising:
a body having a central area with a top surface configured to receive a rider and a bottom surface configured to contact snow;
a plurality of handles positioned along each side of the body for a rider to grip when riding; and
a plurality of arcuate steering ridges extending along the bottom surface and configured to aid in steering the sled.

9. The snow sled of claim 8, wherein the body includes:
a nose portion at the front end of the body;
a tail portion at the rear end of the body; and
a central portion between the nose portion and the tail portion.

10. The snow sled of claim 9, wherein the plurality of handles includes three pairs of handles:
a first pair positioned near the nose portion on opposite sides of the body;
a second pair positioned near the tail portion on opposite sides of the body; and
a third pair positioned between the nose portion and the central portion on opposite sides of the body.

11. The snow sled of claim 10, wherein a rider in a prone position may grip one of the first pair of handles on one side of the sled body and one of the third pair of handles on the other side of the sled body and use this grip to shift the rider's weight and cause the sled to turn.

12. The snow sled of claim 10, wherein a rider in a seated position may grip both of the second pair of handles to shift the rider's weight toward one side and to cause the sled to turn towards that side.

13. The snow sled of claim 8, wherein the body includes a sheet of foam plastic adhered to the top surface of the sled.
